(19) United States
(12) Patent Application Publication
(10) Pub. No.: US 2023/0406992 A1
(43) Pub. Date: Dec. 21, 2023

(54) METHOD FOR USING CO2-BASED POLYOL ON POLYURETHANE FOAM TO IMPROVE REPROCESSING-ABILITY IN HOT PROCESS WITH SUPERIOR RECYCLING RATE

(71) Applicants: Ford Motor Company, Dearborn, MI (US); Washington State University, Pullman, WA (US)

(72) Inventors: Alper Kiziltas, Sarikamis (TR); Deborah Frances Mielewski, Ann Arbor, MI (US); Wangcheng Liu, Pullman, WA (US); Jinwen Zhang, Pullman, WA (US)

(73) Assignees: Ford Motor Company, Dearborn, MI (US); Washington State University, Pullman, WA (US)

(21) Appl. No.: 17/845,205

(22) Filed: Jun. 21, 2022

(51) Int. Cl. C08G 18/42; C08G 18/76; C08G 18/48; C08J 9/12

(52) U.S. Cl. CPC C08G 18/4244; C08G 18/7692; C08G 2101/00; C08J 9/125; C08G 18/4829

(57) ABSTRACT

A recyclable polyurethane foam is produced by reacting a carbon dioxide-based polyol-containing composition and an isocyanate composition. The polyurethane foam may include a molar ratio of active hydrogen to isocyanate groups of 1:0.9. The polyurethane foam may include a catalyst at about greater than or equal to about 0.5 to less than or equal to about 1.5 parts by weight percent.

### FIELD

The present disclosure relates to recyclable polyurethane foams.

### BACKGROUND

The statements in this section merely provide background information related to the present disclosure and may not constitute prior art.

Conventional methods for developing polyurethane foams typically include reacting a mixture with at least one polyol with hydroxyl groups (such as petroleum-based polyols) (also referred to herein as a polyol-containing composition) with a mixture having at least one diisocyanate and/or polyisocyanate (also referred to herein as an isocyanate composition) in the presence of additives, such as blowing agents, surfactants, catalysts, and any other desired additives by forming a gas (e.g., carbon dioxide) while urethane polymerization occurs (the mixture of the polyol mixture, the isocyanate mixture, and any additives is also referred to as a reaction mixture). The polyol mixture can include additives. The gas is formed as a result of the blowing agent, which typically is water, reacting with the isocyanates, thereby forming carbon dioxide and polyurea linkages. Other additives enhance the properties of the resulting foam, control the aforementioned reactions, and the like.

Polyurethane foams are thermosets and accordingly, at their useful end of life, it may be challenging to reuse or recycle such polyurethane foams. Vitrimers are a recently introduced kind of crosslinked polymer material that has plastic-like properties and features under high temperature. More particularly, vitrimers exhibit malleability at high temperatures, allowing for re-arrangement of the macromolecular network and thereby allowing for reprocessability. The carbamate and carbamide bonds of polyurethane are noted to be inherently interchangeable, rendering a degree of rearrangement of the network structure and hence a kind of reprocessability. However, the reprocessing of polyurethane is usually a slow process, especially for those prepared from petroleum-based ether polyols. Though high processing temperatures (like 180-220° C.) can promote the network rearrangement and hence improve reprocessability, thermal degradation and decomposition of polyurethane likely occur at temperature >160° C.

These issues related to the design of recyclable polyurethane foams, particularly in automotive applications, are addressed by the present disclosure.

### SUMMARY

This section provides a general summary of the disclosure and is not a comprehensive disclosure of its full scope or all of its features.

According to one form of the present disclosure, a polyurethane foam is produced by reacting a polyol-containing composition with an isocyanate composition. The polyol-containing composition includes a carbon dioxide-based polyol having a molar ratio of active hydrogen to isocyanate groups of 1:0.9.

In variations of this polyurethane foam, which may be implemented individually or in any combination: the polyurethane foam further includes at least one of a cell opener, a surfactant, a cross-linking agent, a catalyst, and a water blowing agent; the polyol-containing composition includes a cell opener at about 2 parts by weight percent, a surfactant at about 0.5 parts by weight percent, a cross-linking agent at about 1.5 parts by weight percent, a catalyst at greater than or equal to about 0.5 parts by weight percent, and a water blowing agent at about 3 parts by weight percent; the polyol-containing composition comprises a catalyst at greater than or equal to about 0.5 parts by weight percent to less than or equal to about 1.5 parts by weight percent; the polyurethane foam has a strength at break of greater than or equal to about 124 kPa; the polyurethane foam has a specific modulus of greater than or equal to about 4 kNm/kg; and a vehicle component is formed of the polyurethane foam.

In another form of the present disclosure, a polyurethane foam is produced by reacting a polyol-containing composition with an isocyanate composition. The polyol-containing composition includes a CO₂-polyol including a catalyst at greater than or equal to about 0.5 parts by weight percent to less than or equal to about 1.5 parts by weight percent.

In variations of this polyurethane foam, which may be implemented individually or in any combination: the polyurethane foam further includes at least one of a cell opener, a surfactant, a cross-linking agent, a catalyst, and a water blowing agent; the polyol-containing composition includes a cell opener at about 2 parts by weight percent, a surfactant at about 0.5 parts by weight percent, a cross-linking agent at about 1.5 parts by weight percent, and a water blowing agent at about 3 parts by weight percent; the polyol-containing composition has a molar ratio of active hydrogen to isocyanate groups of 1:0.9; the polyurethane foam has a strength at break of greater than or equal to about 124 kPa; the polyurethane foam has a specific modulus of greater than or equal to about 4 kNm/kg; and a vehicle component is formed of the polyurethane foam.

In yet another form, a polyurethane foam is produced by reacting a polyol-containing composition with an isocyanate composition. The polyol-containing composition includes a CO₂-polyol including a catalyst at about 1.5 parts by weight percent.

In variations of this form, which may be implemented individually or in any combination: the polyol-containing composition has a molar ratio of active hydrogen to isocyanate groups of 1:0.9; the polyurethane foam further includes at least one of a cell opener, a surfactant, a cross-linking agent, a catalyst, and a water blowing agent; the polyol-containing composition includes a cell opener at about 2 parts by weight percent, a surfactant at about 0.5 parts by weight percent, a cross-linking agent at about 1.5 parts by weight percent, and a water blowing agent at about 3 parts by weight percent; the polyurethane foam has a strength at break of greater than or equal to about 124 kPa; and the polyurethane foam has a specific modulus of greater than or equal to about 4 kNm/kg.

Further areas of applicability will become apparent from the description provided herein. It should be understood that the description and specific examples are intended for purposes of illustration only and are not intended to limit the scope of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features.

As used herein, “isocyanates” include diisocyanates such as aromatic diisocyanates, toluene diisocyanates (“TDI”), and methylene diphenyl diisocyanates (“MDI”), as well as polyisocyanates, and mixtures thereof. Non-limiting examples of isocyanates include methylene diphenyl diisocyanate (MDI), toluene diisocyanate (TDI), hexamethylene diisocyanate (HDI), isophorone diisocyanate (IPDI), 4,4′-diisocyanatodicyclohexylmethane (H12MDI), 1,5-naphthalenediisocyanate (NDI), tetramethyllxylenediisocyanate (TMXDI), p-phenylenediisocyanate (PPDI), 1,4-cyclohexane diisocyanate (CDI), tolidine diisocyanate (TODI), and combinations thereof. It is contemplated isocyanates may include polymeric materials.

As used herein, “petroleum-based polyols” (hereafter “petro-polyol”) are polyether polyols which can be used in the practice of the present disclosure and are well known and widely available commercially. Such polyols are generally at least about 80% by weight or more of a composition or blend of compositions directly or indirectly obtained from a non-renewable resource such as crude oil. In other variations, the polyols are generally at least about 85% by weight, at least 90% by weight, and/or at least 95% by weight or more of a composition or blend of compositions directly or indirectly obtained from a non-renewable resource such as crude oil. Non-limiting examples of the polyether polyols include polyoxyethylene glycol, polyoxypropylene glycol, polyoxybutylene glycol, polytetramethylene glycol, block copolymers, for example, combinations of polyoxypropylene and polyoxyethylene glycols, poly-1,2-oxybutylene and polyoxyethylene glycols, poly-1,4-tetramethylene and polyoxyethylene glycols, and random and block copolymer glycols prepared from blends or sequential addition of two or more alkylene oxides. The mechanical properties of the resultant polyurethane foam may dictate the consistency of the polyol. More specifically, higher molecular weight polyols generally form more flexible polyurethanes, whereas lower molecular weight polyols generally form more rigid polyurethanes.

As used herein, carbon dioxide-based polyols are poly(ether carbonate) polyols (hereafter “CO₂-polyol. Non-limiting examples of CO₂-polyols include CARDYON® LC-05, available from Covestro Deutschland AG.

As noted above, polyurethane foams are typically prepared by reacting isocyanates with polyols in the presence of additives. In such a manner, it is contemplated that a polyol solution according to the present disclosure includes at least a petro-based polyol, a CO₂-based polyol and any desired additives. Such additives, some of which may be optional, include at least one of a cell opener, a surfactant, a cross-linking agent, a catalyst, and a water blowing agent. It is also contemplated that a polyol solution may include a petro-based polyol, carbon dioxide-based polyol, reinforcements, and any desired additives.

Blowing agents assist in preparing foam, and water is highly desirable as a blowing agent. Other blowing agents suitable according to the present disclosure include fluorocarbons, hydrochlorocarbons, chorofluorocarbons, hydrofluorocarbons, hydrocarbons. It is also contemplated that gas may be added directly to the polyol isocyanate reaction mixture to form the foam.

Surfactants are useful for cell nucleation and cell opening in foam applications and offer foam stabilization. One desirable surfactant is TEGOSTAB® B 4690, available from Evonik Degussa, but it is contemplated other nonionic surfactants may be suitable for preparing the polyurethane foams disclosed herein.

Cross-linking agents may be used to improve the crosslinked network, control flexural and other properties of the foam. Suitable cross-linking agents include diethanolamine (DEA) and triethanolamine, which, when used in foam application, build firmness and increase catalytic activity.

Catalysts enhance the processing characteristics and physical properties of polyurethane foams by promoting the basic chemical reactions between polyol and isocyanate, reactions between water and isocyanate, and reactions to trimerizate isocyanates. Catalysts may be selected according to the needs of a particular application, for example, to improve the polyether foaming process of a wide variety of foams, including high-density unfilled foam, filled foam, high load-bearing flexible foam, low-density foam, and high resilience molded foam. Other catalysts may be selected to delay the foam-forming reaction process, which can result in more open foam structures. Suitable catalysts according to the present disclosure are dibutyltin dilaurate (DBTDL) and diluted amine ethers, such as NIAX® A1 and liquid, water-soluble tertiary amines, such as NIAX® A-300, each of which are available from Momentive Performance Materials. Tertiary amines may be desirable as catalysts when water is present in the polyol isocyanate reaction mixture, as it catalyzes the isocyanate to react with water to form urea linkages with urethane. According to a form, the catalyst may comprise a first catalyst comprised of a diluted amine ether, and a second catalyst comprised of a water-soluble tertiary amine.

Cell openers may be used to prepare foam structures that have predominantly open cells, which gives it a larger value of air permeability and include water-soluble emulsifiers, such as LUMULSE® POE (26) GLYC, available from Vantage Specialty Chemicals, Inc.

Other optional additives include buffers, dendritic macromolecules, inorganic particulates, other types of polyols not listed herein, polyisocyanates, flame retardants, deodorants, colorants, fillers, combinations thereof, and other additives known to those familiar with the technology.

Carbon Dioxide-Based Polyurethane Foams

CO₂-polyol-based foams of different compositions as shown below in Table 1 were prepared and tested according to the teachings of the present disclosure. A foam based on petro-polyol was also prepared as a reference (control). In the compositions below, the CO₂-polyol was CARDYON LC-05, the petro-polyol was VORANOL 4701, the cell opener was LUMULSE POE (26), the surfactant was nonreactive and TEGOSTAB B4690, the crosslinker was DEA, the catalyst was DBTDL, the blowing agent was water, and the isocyanate was RUBINATE 7304. During preparing the formulation of foam, the molar ratios of active hydrogen M(H) to isocyanate (M(NCO)) was 1:0.9 for samples 1-3 and the control and 1:1 for sample 4, respectively. As used herein, the active hydrogens include those in the hydroxyl groups of polyol, hydroxyl and amine groups of crosslinker (e.g., DEA) and the 2 hydrogens of water.

TABLE 1
Example/Test Compositions of Petroleum (Control) and CO₂-Based
(Sample-1-4) Polyurethane Foams in Parts by Weight Percent

| | Petro- | | | | |
|---|---|---|---|---|---|
| | polyol | CO₂-polyol based foam | | | |
| | based foam | Sample- | Sample- | Sample- | Sample- |
| | control | 1 | 2 | 3 | 4 |
| CO₂-polyol | 0 | 100 | 100 | 100 | 100 |
| Petro-polyol | 100 | 0 | 0 | 0 | 0 |
| Cell opener | 2 | 2 | 2 | 2 | 2 |
| Surfactant | 0.5 | 0.5 | 0.5 | 0.5 | 0.5 |
| Crosslinker (DEA) | 1.5 | 1.5 | 1.5 | 1.5 | 1.5 |
| Catalyst (DBTDL) | 0.925 | 0.5 | 1 | 1.5 | 1 |
| Blowing agent (H₂O) | 3 | 3 | 3 | 3 | 3 |
| Isocyanate | 51.4 | 55.3 | 55.3 | 55.3 | 61.4 |

The working examples were produced according to the following procedure. First, a polyol mixture was formed by mixing together about 100 parts by weight percent petro-polyol (e.g., VORANOL® 4701, available from Dow Chemical Co.) or about 100 parts by weight percent CO₂-polyol (e.g., CARDYON® LC-05, available from Covestro Deutschland AG), about 2 parts by weight percent cell opener (e.g., LUMULSE® POE (26) GLYC available from Lambent Corporation), about 0.5 parts by weight percent surfactant (e.g., TEGOSTAB® B4690, available from Evonik Nutrition & Care GmbH), about 1.5 parts by weight percent cross-linking agent (e.g., DEA), about 0.925 parts by weight percent to about 1.5 parts by weight percent of a catalyst (e.g., DBTDL), and about 3 parts by weight percent blowing agent (e.g., deionized water) with a handheld mixer at 1500 rpm for about five minutes. An isocyanate (e.g., RUBINATE® 7304, available from Huntsman International LLC) was added to the polyol mixture and mixed with the mixer for 12 seconds. The reaction mixture was poured into a closed mold system that had been coated with Chem-Trend PU-11331 release agent and warmed in a pre-heated oven at 85° C. for 10 minutes, followed by curing at 85° C. for 2 hours. The foams did not exhibit overflowing or insufficient molding and exhibited good pore dispersion and distribution.

The resultant foams of the working examples shown in Table 1 had modulus, strength at break, elongation at break, density, specific strength, and specific modulus tested according to ASTM Tests. Table 2 below shows the results of the respective tests. (Parentheticals represent standard deviation).

TABLE 2
Mechanical Properties of Compositions Formed According to Table 1

| | | | | | Specific | Specific |
|---|---|---|---|---|---|---|
| | Modulus | Strength at | Elongation | Density | strength | modulus |
| Sample | (kPa) | break (kPa) | at break (%) | (kg/m³) | (kNm/kg) | (kNm/kg) |
| Control | 110.9 (7.2) | 64.8 (9.8) | 55.5 (10.6) | 57.9 (3.5) | 1.12 | 1.92 |
| Sample-1 | 229.7 (22.9) | 124.6 (10.9) | 64.4 (4.3) | 55.9 (1.6) | 2.23 | 4.1 |
| Sample-2 | 230.6 (22.6) | 147.8 (8.5) | 88.6 (11.6) | 53.5 (0.6) | 2.76 | 4.31 |
| Sample-3 | 265.7 (26) | 161.4 (21.7) | 86.4 (6.3) | 55.4 (1.3) | 2.91 | 4.8 |
| Sample-4 | 1109.8 (76.6) | 222.6 (10) | 51.1 (12.1) | 67.8 (1) | 3.28 | 16.36 |

As shown in Table 2, the petro-polyol based foam exhibits more flexibility but is weaker than the CO₂-polyol based foams. The CO₂-polyol based foams are also more rigid than the petro-polyol based foam at room temperature, but their polyol segments are still in the rubber state. Due to higher isocyanate content, sample-4 is relatively stiffer than the other three CO₂-polyol based foams. Sample-2 and sample-3 contained higher catalyst contents than sample-1 and hence resulted in better completion of curing reaction, exhibiting higher mechanical properties.

The petro-polyol based foam exhibited better thermal stability characteristics than the CO₂-polyol based foams. While not wishing to be bound by theory, this may be attributed to a better thermal stability of ether bonds formed in the petro-polyol based foams, as opposed to carbonate bonds formed in the CO₂-polyol based foams.

The foams prepared according to Table 1 were then subjected to thermal reprocessing to produce densified sheet products. More specifically, the foams were hot-pressed under 10 MPa pressure and 140° C. temperature for 60 minutes. Subsequently modulus, strength at break, elongation at break, density, specific strength, and specific modulus of the resulting sheet were tested according to ASTM Tests. Table 3 below shows the results of the respective tests. (Parentheticals represent standard deviation).

TABLE 3
Mechanical Properties of Sheets Formed According to Table 1 After First-
Round Thermal Reprocessing

| | | | | | Specific | Specific |
|---|---|---|---|---|---|---|
| | Modulus | Strength at | Elongation | Density | strength | modulus |
| Sample | (kPa) | break (kPa) | at break (%) | (kg/m³) | (kNm/kg) | (kNm/kg) |
| Control | 11.1 (1.8) | 6.9 (0.3) | 105.3 (3.7) | 1.10 (0.02) | 6.27 | 10 |
| Sample-1 | 17.5 (0.7) | 9 (0.9) | 94 (2.3) | 1.11 (0.01) | 8.1 | 15.76 |
| Sample-2 | 18.8 (1.6) | 9.5 (0.7) | 97.2 (5.8) | 1.09 (0.02) | 8.71 | 17.24 |
| Sample-3 | 19.2 (1.7) | 9.5 (1.5) | 89.3 (10.6) | 1.1 (0.03) | 8.63 | 17.45 |
| Sample-4 | 101.7 (10.2) | 19.8 (1.2) | 63.2 (8.9) | 1.09 (.01) | 18.19 | 93.33 |

The foams prepared according to Table 1 were each cut up into eight pieces and then thermally reprocessed by a hot-press process at 10 MPa pressure and a 140° C. temperature for 60 minutes. Subsequently, the reprocessed sheets were cooled to room temperature and had modulus, strength at break, elongation at break, density, specific strength, and specific modulus tested according to ASTM Tests. Table 4 below shows the results of the respective tests. (Parentheticals represent standard deviation).

TABLE 4
Mechanical Properties of Sheets Formed According to Table 1 After First-
Round Thermal Reprocessing

| | | | | | Specific | Specific |
|---|---|---|---|---|---|---|
| | Modulus | Strength at | Elongation | Density | strength | modulus |
| Sample | (MPa) | break (MPa) | at break (%) | (g/cm³) | (kNm/kg) | (kNm/kg) |
| Control | 8.6 (0.7) | 4.9 (0.4) | 79.4 (4.2) | 1.08 (0.02) | 4.53 | 7.96 |
| Sample-1 | 19.3 (0.8) | 9.3 (1.1) | 85.5 (11.6) | 1.09 (0.02) | 8.53 | 17.71 |
| Sample-2 | 20.3 (0.9) | 9.1 (0.4) | 86.5 (3.3) | 1.09 (0.02) | 8.34 | 18.6 |
| Sample-3 | 21.2 (2.3) | 9.6 (1.1) | 85.2 (12.5) | 1.11 (0.03) | 8.65 | 19.09 |
| Sample-4 | 112.5 (11.3) | 19.2 (2.8) | 64.1 (13.6) | 1.11 (0.02) | 17.61 | 101.3 |

The reprocessed sheets were further cut up into sixteen pieces and then thermally reprocessed by a hot-press process at 10 MPa pressure and a 140° C. temperature for 60 minutes. This process is regarded as a second-round reprocessing. Subsequently, modulus, strength at break, elongation at break, density, specific strength, and specific modulus of the sheet were tested according to ASTM Tests. Table 5 below shows the results of the respective tests. (Parentheticals represent standard deviation).

TABLE 5
Mechanical Properties of Sheets Formed According to Table 1 After Second-
Round Thermal Reprocessing

| | | | | | Specific | Specific |
|---|---|---|---|---|---|---|
| | Modulus | Strength at | Elongation | Density | strength | modulus |
| Sample | (MPa) | break (MPa) | at break (%) | (g/cm³) | (kNm/kg) | (kNm/kg) |
| Control | 30.3 (8.9) | 1.1 (0.8) | 7.1 (5.2) | 1.08 (0.01) | 1.01 | 28.05 |
| Sample-1 | 31.6 (4.9) | 3.7 (0.5) | 19.4 (4) | 1.07 (0.01) | 3.45 | 29.53 |
| Sample-2 | 82.3 (9.4) | 6.9 (0.9) | 28.8 (11.3) | 1.08 (0.02) | 6.38 | 76.2 |
| Sample-3 | 89.4 (6.7) | 4.7 (0.4) | 8.2 (1.5) | 1.09 (0.01) | 4.31 | 82.02 |
| Sample-4 | 173.6 (34.3) | 11.6 (1.4) | 25.8 (7.7) | 1.08 (0.02) | 10.74 | 160.74 |

As shown with Tables 3, 4, and 5, the reprocessed CO₂-polyol based sheets (Sample-1˜4) retained much of their mechanical properties after successive heat and stress treatments, whereas the reprocessed petro-polyol based sheets (Control) quickly lost their mechanical properties. Without wishing to be bound by theory, this result suggests that CO₂-polyol based foams exhibited thermoplastic-like malleability at temperatures of 40˜160° C., whereas the petro-polyol based sheets retained their thermoset properties and displayed poor malleability for thermal reprocessing. As such, it is believed that the CO₂-polyol based foams could be easily recycled through thermoplastic processing techniques, and the reprocessed CO₂-polyol based sheet (e.g., sample-2 and sample-3) could be recycled multiple times, whereas that is not practically feasible with petro-polyol based foams. Moreover, with higher catalyst content (e.g., in sample-2 and sample-3), it appears there is a quicker rate of stress relaxation, which provides the CO₂-polyol based foams with better molecular mobility and accordingly even better recyclable and reusable properties.

The polyurethane foams disclosed herein may be used in various applications where it is desirable to have foams having the properties disclosed herein, e.g., such as foams for the furniture industry. Further, the polyurethane foams disclosed herein may be used in various automotive applications and for vehicle components, including but not limited to seat backs, arm rests, seat cushions, headliner applications, head rests, NVH (noise, vibration, and harshness) foams, engine covers, oil pump covers, air conditioning compression covers, fuel covers, and under the hood covers.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A polyurethane foam produced by reacting a polyol-containing composition and an isocyanate composition, wherein the polyol-containing composition comprises a carbon dioxide-based polyol (CO₂-polyol) having a molar ratio of active hydrogen to isocyanate groups of 1:0.9.

2. The polyurethane foam according to claim 1, wherein the polyurethane foam further comprises at least one of a cell opener, a surfactant, a cross-linking agent, a catalyst, and a water blowing agent.

3. The polyurethane foam according to claim 1, wherein the polyol-containing composition further comprises:
a cell opener at about 2 parts by weight percent;
a surfactant at about 0.5 parts by weight percent;
a cross-linking agent at about 1.5 parts by weight percent;
a catalyst at greater than or equal to about 0.5 parts by weight percent; and
a water blowing agent at about 3 parts by weight percent.

4. The polyurethane foam according to claim 1, wherein the polyol-containing composition comprises a catalyst at greater than or equal to about 0.5 parts by weight percent to less than or equal to about 1.5 parts by weight percent.

5. The polyurethane foam according to claim 1, wherein the polyurethane foam has a strength at break of greater than or equal to about 124 kPa.

6. The polyurethane foam according to claim 1, wherein the polyurethane foam has a specific modulus of greater than or equal to about 4 kNm/kg.

7. A vehicle component comprised of the polyurethane foam of claim 1.

8. A polyurethane foam produced by reacting a polyol-containing composition and an isocyanate composition, wherein the polyol-containing composition comprises a CO₂-polyol comprising a catalyst at greater than or equal to about 0.5 parts by weight percent to less than or equal to about 1.5 parts by weight percent.

9. The polyurethane foam according to claim 8, wherein the polyurethane foam further comprises at least one of a cell opener, a surfactant, a cross-linking agent, and a water blowing agent.

10. The polyurethane foam according to claim 8, wherein the polyol-containing composition further comprises:
a cell opener at about 2 parts by weight percent;
a surfactant at about 0.5 parts by weight percent;
a cross-linking agent at about 1.5 parts by weight percent; and
a water blowing agent at about 3 parts by weight percent.

11. The polyurethane foam according to claim 8, wherein the polyol-containing composition comprises a molar ratio of active hydrogen to isocyanate groups of 1:0.9.

12. The polyurethane foam according to claim 8, wherein the polyurethane foam has a strength at break of greater than or equal to about 124 kPa.

13. The polyurethane foam according to claim 8, wherein the polyurethane foam has a specific modulus of greater than or equal to about 4 kNm/kg.

14. A vehicle component comprised of the polyurethane foam of claim 8.

15. A polyurethane foam produced by reacting a polyol-containing composition and an isocyanate composition, wherein the polyol-containing composition comprises a CO₂-polyol comprising a catalyst at about 1.5 parts by weight percent.

16. The polyurethane foam according to claim 15, wherein the polyol-containing composition comprises a molar ratio of active hydrogen to isocyanate groups of 1:0.9.

17. The polyurethane foam according to claim 15, wherein the polyurethane foam further comprises at least one of a cell opener, a surfactant, a cross-linking agent, and a water blowing agent.

18. The polyurethane foam according to claim 15, wherein the polyol-containing composition further comprises:
a cell opener at about 2 parts by weight percent;
a surfactant at about 0.5 parts by weight percent;
a cross-linking agent at about 1.5 parts by weight percent; and
a water blowing agent at about 3 parts by weight percent.

19. The polyurethane foam according to claim 15, wherein the polyol-containing composition has a strength at break of greater than or equal to about 124 kPa.

20. The polyurethane foam according to claim 15, wherein the polyurethane foam has a specific modulus of greater than or equal to about 4 kNm/kg.
